(19) United States
(12) Patent Application Publication
(10) Pub. No.: US 2004/0044897 A1
(43) Pub. Date: Mar. 4, 2004

(54) Biometrics parameters protected computer serial bus interface portable data storage device and method of proprietary biometrics enrollment

(76) Inventor: Boon Lum Lim, Singapore (SG)

Correspondence Address: CLARK & BRODY, Suite 600, 1750 K Street, NW, Washington, DC, 20006, US

(21) Appl. No.: 10/423,001

(22) Filed: Apr. 25, 2003

(30) Foreign Application Priority Data
Apr. 25, 2002 (SG) 200202498-2

(51) Int. Cl. H04L 9/00; H04K 1/00

(52) U.S. Cl. 713/186; 713/202

(57) ABSTRACT

A biometric parameters protected computer serial bus interface portable data storage device which integrates the computer serial bus interface with biometric (Fingerprint) technologies to ensure data and information storage within the device are secured with personal biometrics information. The storage device acts as a portable hard disk which can be connected via computer serial bus interface onto any computer platform with computer serial bus host and only the user(s) with the authorized fingerprint bio-data can have access to the data stored in the device.

### BACKGROUND OF THE INVENTION

(1) Field of the Invention

The present invention relates to portable data storage device, and in particular, a data storage device which integrates computer serial bus interface with biometric (Fingerprint) technologies to ensure data and information storage within the device is secured with personal biometrics information. The storage device acts as a portable hard disk which can be connected via computer serial bus interface onto any computer platform with computer serial bus host. The user can then access and retrieve data stored in the storage device or store data into the storage device. As the data in the device is protected by a personal information biometrics key, only the person with the authorized fingerprints can activate the function of the storage device.

(2) Description of the Art

Prior art devices use a sensoring device for sensing biometric characteristics such that the device is connected via computer serial bus to a system and that biometric identification is required to launch the function of the said system. U.S. Pat. No. 6,125,192 discloses a fingerprint sensor that is connected to a digital system via computer serial bus such that access of the digital system requires fingerprint authentication. Similarly, U.S. Pat. No. 6,353,472 discloses a device for the authentication of a person by his fingerprints prior to an authorization for an operation, and that the connection of this device to the mode of operation can be via computer serial bus interface. None of the prior art suggest the use of fingerprint authentication on a portable hard disk which can be linked to a computer platform via computer serial bus such that fingerprint authentication is required to access information stored in the said disk.

U.S. Pat. No. 4,210,899 to Swonger et al. discloses an optical scanning fingerprint reader cooperating with a central processing station for a secure access application, such as admitting a person to a location or providing access to a computer terminal. U.S. Pat. No. 4,525,859 to Bowles similarly discloses a video camera for capturing a fingerprint image and uses the minutiae of the fingerprints, that is, the branches and endings of the fingerprint ridges, to determine a match with a database of reference fingerprints. Unfortunately, stained fingers may affect optical sensing or an optical sensor may be deceived by presentation of a photograph or printed image of a fingerprint rather than a true live fingerprint. Optical sensors may be bulky and be susceptible to shock, vibration and surface contamination. Accordingly, an optical fingerprint sensor may be unreliable in service in addition to being bulky and relatively expensive due to optics and moving parts. It is therefore an object of the present invention to provide a fingerprint sensor and related methods of accurately sensing a fingerprint, and which sensor is compact, reliable and relatively inexpensive.

Accordingly, the many shortcomings and disadvantages of prior art optical sensors are overcome in the present invention with the use of capacitive or electric field sensors.

### SUMMARY OF THE INVENTION

The object of the invention is to provide a biometric parameters protected computer serial bus interface portable data storage device wherein information storage within the device is secured with personal biometrics information. In addition, the communication path between any computer platform (with computer serial bus host) and the information stored in the device is via a computer serial bus client/host interface such as USB, FireWire (IEEE1394) or anything serially connected from a computer.

An aspect of the present invention is to provide a biometrics protected computer serial bus interface portable data storage device, comprising:

an embedded fingerprint biometrics processing unit and sensor, wherein the sensor can be either any of the capacitive or electric field sensing devices;

a flash memory or flash memories which is a storage device and is able to store data and information, with any storage capacity;

a micro-controller and data processing unit which is a device responsible for interfacing with the embedded fingerprint processing unit, the host computer system and the memory storage, and being a gateway for data to store/retrieve in/from the flash memory with biometric information protection;

a built in proprietary data encryption scheme for data and information safe keeping within the memory storage; and

a proprietary enrollment scheme for biometric fingerprint enrollment.

With the proliferation of computers and computer networks into all aspects of business and daily life—financial, medical, education, government, and communications—the concern over secure data access is growing. One method of providing security from unauthorised access to data is the use of personal biometric data instead of passwords to gain access to the data. Unlike passwords, personal biometric data is unique and cannot be stolen or reproduced, hence only the person authorised to view the data can do so.

The present invention utilises a proprietary data encryption scheme wherein the data stored in the biometric parameters protected computer serial bus interface portable data storage device is protected by a personal fingerprint biometrics key and the data can be accessed only when the authorised fingerprint is being inputted into the fingerprint biometrics processing unit.

Yet another object of the present invention is to a biometrics parameters protected computer serial bus interface portable data storage device, which is an easy to use portable miniature data storage device with high storage capacity. The present invention is small in size and is capable of storing huge files such as accounting data files, CAD files, huge presentation files, multimedia files.

Another object of the present invention is to provide a biometrics parameters protected computer serial bus interface portable data storage device which is user friendly, just plugged it into any computer platform via the computer serial bus interface unit, and provide the authorised fingerprint and data can be accessed on the computer platform.

Yet another objective of the present invention is to provide a fast method of accessing the data stored in the biometric parameters protected computer serial bus interface portable data storage device. This can be seen from its short biometrics verification and system access time.

Yet another objective of the present invention is to provide a biometric parameters protected computer serial bus interface portable data storage device which not more than 25 users are assigned for authority access right.

Yet another object of the present invention is provide a biometrics parameters protected computer serial bus interface portable data storage device which utilizes encryption keys to secure data storage within the portable data storage device in its proprietary Data Bio-Encryption Scheme as shown in FIG. 3.

### BRIEF DESCRIPTION OF THE DRAWINGS

The present invention will be more clearly understood when considered in conjunction with the accompanying drawings, in which:

FIG. 1 is a diagram of the biometrics parameters protected computer serial bus interface portable data storage device in accordance with the present invention.

FIG. 2 is a flow chart of the System Functional Block Diagram in accordance with the present invention.

FIG. 3 is a flow chart of the Functional Flows of Proprietary Data Bio-Encryption Scheme in accordance with the present invention.

### DETAILED DESCRIPTION OF THE INVENTION

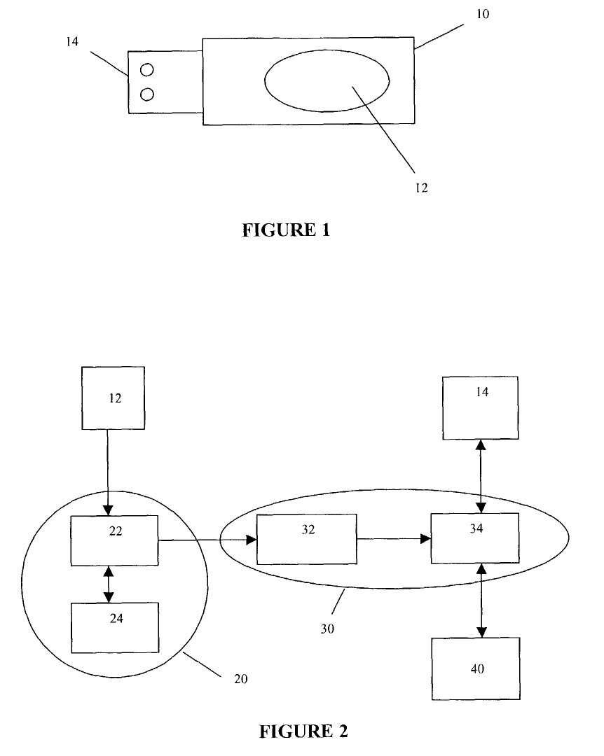

Referring now to the figures of the drawing in detail and first, particularly to FIGS. 1 and 2 thereof, there is shown a portable data storage device 100 which comprises a computer serial bus interface unit 14, a fingerprint sensor 12 and a casing 10 which encloses the embedded fingerprint biometrics processing unit 20, a micro controller and data processing unit 20 and a flash memory 40. In a preferred embodiment of the present invention, the fingerprint sensor 12 is connected to the micro-controller and data processing unit 20 including the fingerprint biometric processing unit 20 and a bio-data storage unit. The biometrics processing unit 22 is connected to the access control decision unit 32 and then is connected to the data processing unit 34.

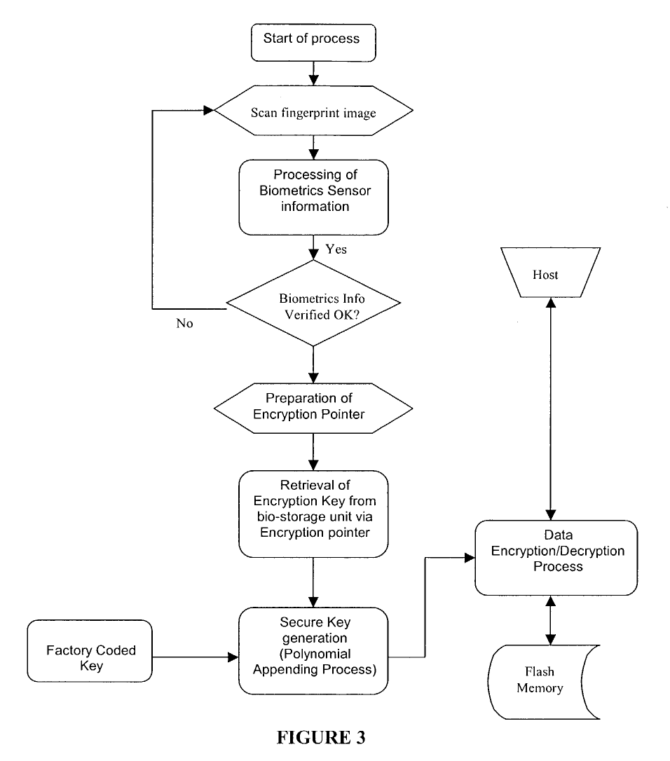

Referring to FIGS. 2 and 3, when in application, the user of the data storage device 100 places his finger onto the fingerprint sensor 12 (which acts as a reader). The sensor 12 scans the user's fingerprint and the fingerprint bio-data is sent to the embedded fingerprint biometrics processing unit 20. In the embedded fingerprint biometrics processing unit 20, a biometrics processing unit 22 verifies the fingerprint bio-data with the enrolled bio-data stored and secured as an Encryption Key in a bio-data storage unit 24. If the verification is unsuccessful, the user will be denied access to the data in the disk or have his fingerprint re-scanned. When the verification is successful, the biometrics processing unit 22 prepares an encryption pointer which retrieves the Encryption key from the bio-data storage unit 24. The Encryption Key retrieved is then secured in a polynomial appending process. A factory coded key or decryption key together with the Encryption Key trigger the data encryption/decryption process in the microcontroller and data processing unit 20. The access control decision unit 32 after being triggered, instructs the data processing unit 34 to extract the information stored in the flash memory 40 and sends it to the computer platform to which the disk is connected to via the host/device computer serial bus interface unit 14.

Before the disk can be used, the user has to enroll his fingerprint bio-data into the embedded fingerprint biometrics processing unit 20. In the first enrollment, the user will have his fingerprint scanned by the fingerprint sensor 12, and the fingerprint bio-data will be processed by the biometrics processing unit 22 and then stored in the biodata storage unit 24. The user must have his fingerprint scanned five times to ensure an accurate reading of the fingerprint bio-data by the biometrics processing unit 22 before being stored into the bio-storage unit 24. Up to a maximum of 25 different fingerprints can be enrolled and therefore up to 25 users can be enrolled.

After the first user is enrolled, if another user wants to have access to the information stored in the disk he will have to be enrolled. Before he can be enrolled, the first user must have his fingerprint authenticated first, and if t is successful the subsequent users can have their fingerprint bio-data enrolled. Their enrollment process is the same as the first user.

In accordance with the present invention, the fingerprint of the user is scanned and verified by the device, which is described hereinafter. In the present method, a data encryption scheme for data and information safe keeping within the biometric parameters protected computer serial bus interface portable data storage device is used and the method comprises the steps as follows:

scanning user's fingerprint by the fingerprint sensor;

processing the scanned fingerprint image by the biometrics processing unit which verifies the image with the user(s) fingerprint bio-data which is stored as encryption key(s) in the bio-data storage unit;

requesting another fingerprint for scanning again from the user if the verification fails;

preparing an encryption pointer which retrieves the encryption key from a bio-data storage unit if the verification is successful; and

securing the encryption key being retrieved in a polynomial appending process.

In the present method, a factory coded key together with the encryption key trigger the data encryption/decryption process in the data processing unit through the access control decision unit; and the data processing unit then extracts data from the flash memory and transmits it to the computer platform through the host/device computer serial bus interface unit.

In accordance with the present invention, the typical biometrics verification and system access time of the portable data storage device is approximately 1 second, and the biometrics enrollment time is approximately 1 second per fingerprint entry, and not more than 25 fingerprints are assigned for authority access right.

While the present invention has been described by means of specific embodiment, it will be understood that modifications may be made without departing from the spirit of the invention The scope of the invention is not to be considered as limited by the description of the invention set forth in the specification, but rather as defined by the following claims.

1. A biometric parameters protected computer serial bus interface portable data storage device comprising:
an embedded fingerprint biometrics processing unit and sensor;
a flash memory for data and information storage and with any storage capacity;
a micro-controller and data processing unit for interfacing with the embedded fingerprint system, a host computer system and the flash memory;
a built-in proprietary data encryption scheme for data and information safe-keeping within the flash memory; and
a proprietary enrollment scheme for biometric fingerprint enrollment.

2. The biometric parameters protected computer serial bus interface portable data storage device of claim 1, wherein the embedded fingerprint biometrics processing unit includes a biometrics processing unit and a bio-data storage unit.

3. The biometric parameters protected computer serial bus interface portable data storage device of claim 1, wherein the biometrics processing unit reads fingerprint bio-data from the fingerprint sensor and stores the bio-data into the bio-data storage unit in the form of an encryption key.

4. The biometric parameters protected computer serial bus interface portable data storage device of claim 2, wherein the bio-data storage unit stores user's fingerprint bio-data.

5. The biometric parameters protected computer serial bus interface portable data storage device of claim 1, wherein the micro-controller and data processing unit includes an access control decision unit and a data processing unit.

6. A method of proprietary data bio-encryption method using biometric parameters protected computer serial bus interface portable data storage device comprising the steps of:
scanning user's fingerprint by the fingerprint sensor;
processing the scanned fingerprint image by the biometrics processing unit which verifies the image with the user(s) fingerprint bio-data which is stored as encryption key(s) in the bio-data storage unit;
requesting another fingerprint for scanning again from the user if the verification fails;
preparing an encryption pointer which retrieves the encryption key from a bio-data storage unit if the verification is successful; and
securing the encryption key being retrieved in a polynomial appending process.

7. The biometric parameters protected computer serial bus interface portable data storage device of claim 1, wherein the typical biometrics verification and system access time is approximately 1 second or less.

8. The biometric parameters protected computer serial bus interface portable data storage device of claim 1, wherein the biometrics enrollment time is 1 second per fingerprint, and not more than 25 fingerprints are assigned for authority access right.
